(19) United States
(12) Patent Application Publication
(10) Pub. No.: US 2012/0093091 A1
(43) Pub. Date: Apr. 19, 2012

(54) METHOD AND SYSTEM FOR EXTENDED SERVICE CHANNEL ACCESS ON DEMAND IN AN ALTERNATING WIRELESS CHANNEL ACCESS ENVIRONMENT

(75) Inventors: Po-Chun Kang, Chiayi County (TW); Tzu-Hsiang Su, Taichung County (TW); Chung-Hsien Hsu, Taichung City (TW); Ta-Yang Juan, Changhua County (TW)

(73) Assignee: INDUSTRIAL TECHNOLOGY RESEARCH INSTITUTE, Hsinchu (TW)

(21) Appl. No.: 12/906,132

(22) Filed: Oct. 17, 2010

(51) Int. Cl. H04W 72/04

(52) U.S. Cl. 370/329

(57) ABSTRACT

Mechanism for extended service channel (SCH) access on demand to improve throughput in an alternating channel access of multiple channels in a wireless environment is provided. Due to characteristics of alternating access to a control channel and a service channel and repeating to broadcast service advertisement packets in IEEE 1609 standards, the disclosure may improve the utilization efficiency of the channels and then increase the transmission throughput.

### BACKGROUND

1. Technical Field

The present invention relates to a method and a system for extended service channel access on demand in an alternating wireless channel access environment.

2. Description of Related Art

With the development of wireless communication, different applications and services are also progressively developed. In recent years, the applications of wireless communication are applied to a vehicular environment, including vehicle-to-vehicle (V2V) and vehicle-to-infrastructure (V2I) wireless communications. In considering requirements of movement and low latency for the vehicles in a wireless network, current Wi-Fi technologies may be not suitable in the vehicular environment. Therefore, the IEEE 1609 family of standards for Wireless Access in Vehicular Environment (WAVE) are developed to address the issues between vehicles and service providers. The IEEE 1609 standards provide a sufficient foundation regarding the organization of management functions and modes of operation devices for the high-speed communications between vehicles and service providers.

In the IEEE 1609 standards, each of the standards is designed to specifically handle applications in different layers referring to the Open System Interconnection (OSI) reference model, such as an application layer, a data link layer or a medium access control (MAC) layer. The IEEE 1609 standards use IEEE 802.11p protocols for their fundamental communications in the MAC and physical (PHY) layers. With the IEEE 1609 standards, devices can simultaneously use multiple channels with different frequencies to provide or receive services. One of the channels is defined as a single control channel (CCH) and the others are defined as service channels (SCHs). The CCH and the SCHs are alternatively switched for communications. The CCH is used for emergency data exchanges and service advertisements by the service provider for advising the user about different services belonging to the SCHs respectively, and each of the SCHs are assigned to transmit or receive these services.

Because of limitations of communications in the PHY layer, single antenna can be used to monitor only one channel. In addition, in the IEEE 1609 standards, the channel stay time is pre-defined to be the same proportion for the CCH and SCH, that is, 50% for the CCH and the other 50% for the SCH, which make the utilization of the channels is not flexible. Although the IEEE 1609 standards specify the extension operation of the SCH access, however, the utilization of the channels is still not satisfied and the flexibility of accessing the channels is still not enough.

Regarding the improvement of the channel utilization, an adaptive channel interval is proposed in U.S. Patent Application No. 20080232433, which is entitled “SYSTEM AND METHOD FOR SHORT RANGE COMMUNICATION USING ADAPTIVE CHANNEL INTERVALS”. The invention proposes an adaptive channel interval for different cases by makes use of the characteristics of the IEEE 1609 standards that the control/safety information (CSI) channel or other channels will be accessed alternatively after a percentage of a duty cycle. For example, when the necessity of accessing the CSI channel is much more than the other services, the percentage of the duty cycle to access the CSI channel will be increased and the percentage of the duty cycle to access other channels will be reduced accordingly.

As shown in FIG. 1, the interval associated with service channel 1 is allocated 30% duty cycle, and the interval associated with service channel 2 is allocated 40% duty cycle. This increases the capacity of the CSI channel since 60% of the time, all devices are available to send and receive on it. The adaptive channel intervals also decrease the average and maximum latency of CSI channel messages. As shown, the same message arriving at time T1 can be immediately delivered on the CSI channel, rather than waiting until T2. The quality of service (throughput and latency) of the two service sets is negatively impacted, but there are numerous services that can tolerate lower throughput and higher latency. The invention requires adaptively increase or decrease the time interval for different channels to improve the channel utilization.

Another improvement of the channel utilization is proposed in the paper “Improving the Channel Utilization of IEEE 802.11p/1609 Networks”, by Wang S. Y., Chou C. L., Ho T. W., Hung W. J., Huang C. F., Hsu M. S., Chen H. Y., Lin C. C., in WCNC 2009, IEEE, p1-6. As shown in FIG. 2, the paper proposes a method of modifying the content of Wave Service Advertisement (WSA), which requests the user changes from an alternative channel access between a CCH and a SCH to a continuous channel access for the SCH when the user receives the request and replies with WSA Acknowledge (WSAA). By using such method, the channel utilization can be improved, and the most bandwidth of the channels can be effectively utilized. However, in an environment of multiple users, if some user joins the service late, the provider can not change back to the CCH, and can not provide the modified WSA again; the user will fail to join the system. In addition, the data to be transmitted should wait for the user's WSAA reply and entering the continuous channel access for the SCH. If the data has a high priority to be transmitted, for example, some emergency security data, it will have some problem if the delayed time is too long. Furthermore, the proposed method is not satisfied with the current IEEE 1609 standards because the content of the WSA format should be modified, and the method is not proved to be widely implemented.

### SUMMARY

Embodiments disclosed herein may provide a method for dynamically adjusting channel utilization rate, adaptive to channel access between a provider and one or a plurality of user devices in a wireless environment. Instead of providing control information on a control channel (CCH) of the related art, in the disclosure, the provider may provide control information on either the CCH, or on the service channel (SCH).

In the method, an access mode of accessing the service content between the provider and the user device by the provider is determined which depends on a requirement of the service between the provider and the user device. The access mode comprises an alternating channel access mode and an extended SCH access mode. The provider advises the user device the access mode between the provider and the user device or the plurality of the user devices. When the access mode being switched from the alternating channel access mode to the extended SCH access mode, the provider first provides the control information on the CCH during CCH intervals then on SCH during following SCH intervals. The user device accesses the control information and the service content on the SCH during the CCH intervals and the SCH intervals until the control information indicates switching the access mode.

In order to make the aforementioned and other features of the present invention more comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments and, together with the description, serve to explain the principles of the invention.

FIG. 1 is a schematic drawing illustrating a conventional method for short range communication using adaptive channel intervals.

FIG. 2 is a schematic drawing illustrating a conventional method for improving the Channel Utilization of IEEE 802.11p/1609 Networks.

FIG. 3 is a schematic drawing illustrating architecture for enabling secure vehicle-to-vehicle (V2V) and vehicle-to-infrastructure (V2I) wireless communications.

FIG. 4 schematically illustrates the architecture in IEEE 1609 Standards for Wireless Access in Vehicular Environments (WAVE).

FIG. 5 schematically illustrates the IEEE 1609 Standards using 5.9 Giga Hertz (GHz) band for communication, and the band is divided into seven channels.

FIG. 6 schematically illustrates the time sequences in an alternating channel access mode and in a continuous channel access mode.

FIG. 7A schematically illustrates a guard interval added between the control channel (CCH) interval and the service channel (SCH) interval for each sync interval (duty cycle) in IEEE 1609 standards.

FIG. 7B schematically illustrates the contents of CCH interval and the SCH interval.

FIG. 8 schematically illustrates communications between the provider and the user device, in which the provider includes two antennas ANT1 and ANT2 for respectively sending control information and service content.

FIG. 9A illustrates content of a Wave Service Advertisement (WSA) packet in the IEEE 1609 standard, and FIG. 9B illustrates further detailed content of the WSA.

FIGS. 10-12 schematically illustrates different cases for communications in the propose system that provides an extended SCH access on demand between a provider and one or more user devices in some embodiments of the disclosure.

FIG. 13 illustrates an exemplary block diagram for a system including a provider 1300 and a user device 1302 in an embodiment of the disclosure.

FIG. 14 illustrates a process associated with the mechanism for extended SCH access on demand between the provider and the user device in one exemplary embodiment of the disclosure.

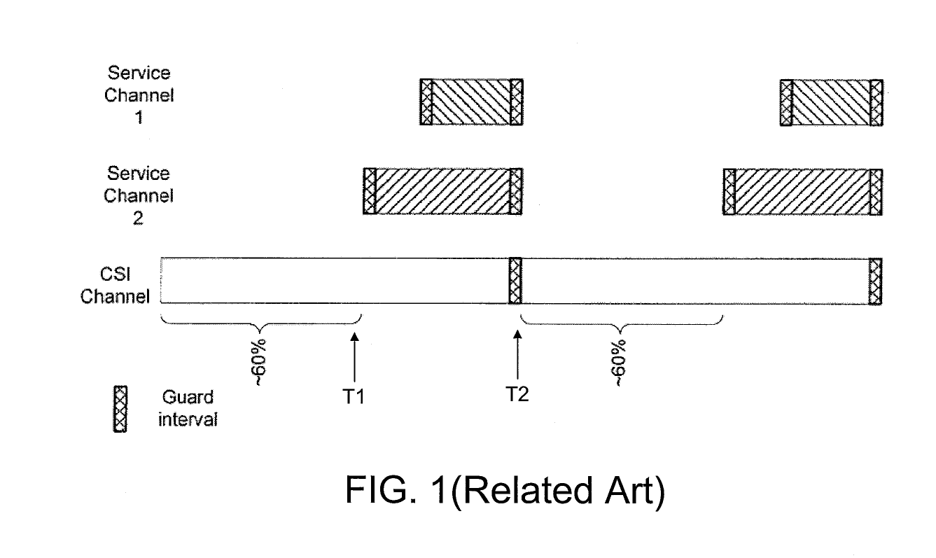

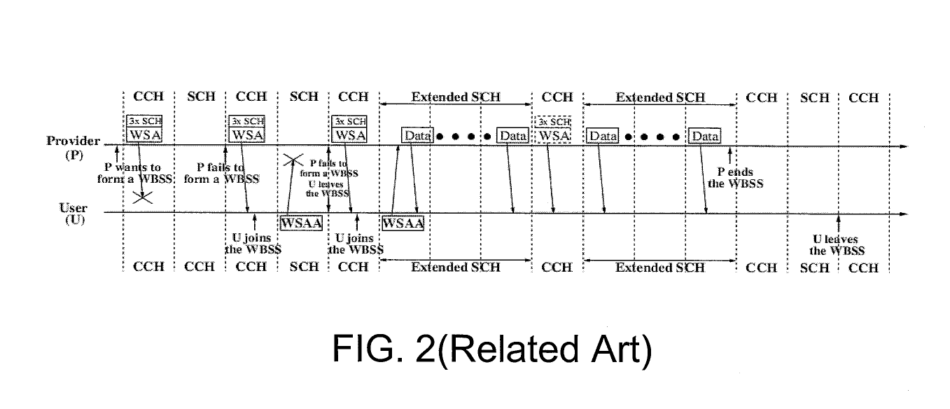

### DESCRIPTION OF DISCLOSED EMBODIMENTS

The disclosure provides mechanism for extended service channel (Extended SCH) access on demand to improve throughput in an alternating channel access of multiple channels in a wireless environment. Due to characteristics of alternating access to the control channel (CCH) and the service channel (SCH) by turn and repeating to broadcast service advertisement packets based on IEEE 1609 standards, the disclosure may improve the utilization efficiency of channel access and then increase the transmission throughput. When the high throughput or specific requirements are occurred, a provider may broadcast a message to temporally extend or interrupt the SCH access on demand. The disclosure may also reduce the affected influence occurred due to communication interference problem by extending the SCH access. The user can dynamically switch the status of the channel access under utilization; therefore, the throughput of the system utilization may be improved.

By makes use of characteristics of IEEE 1609 standards that the CCH or the SCH is accessed alternatively by turn after a predetermined interval within a duty cycle, the disclosure proposes a mechanism which may dynamically terminate the channel switching, and temporarily work on the SCH in order to ensure the quality of service (QoS), better channel utilization and higher throughput.

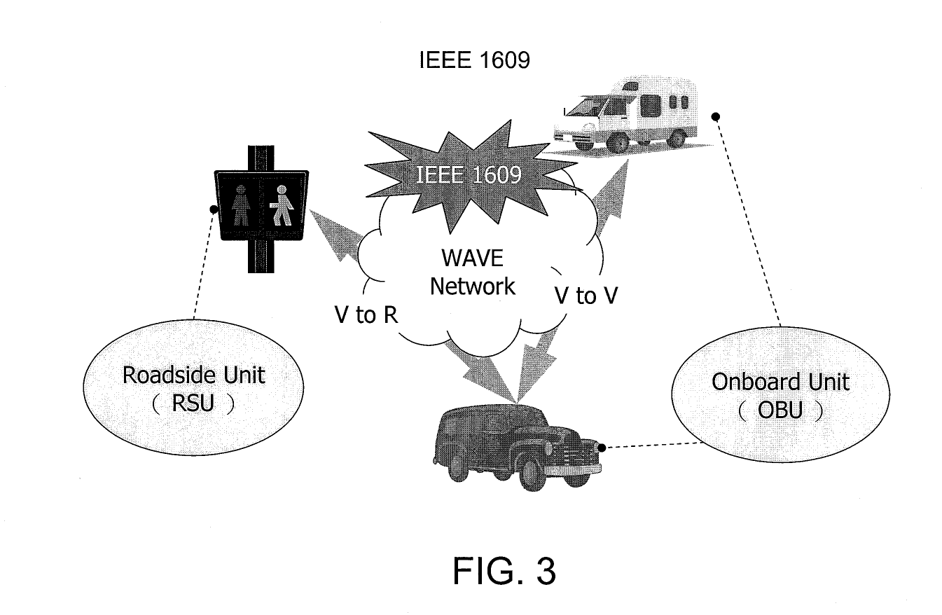

As shown in FIG. 3, WAVE standards define architecture and a complementary, standardized set of services and interfaces that collectively enable secure vehicle-to-vehicle (V2V) and vehicle-to-infrastructure (V2I) wireless communications. The infrastructure includes at lease one or more roadside units (RSU), and the vehicle includes at least one or more onboard units (OBU). Together these standards provide the foundation for a broad range of applications in the transportation environment, including vehicle safety, automated tolling, enhanced navigation, traffic management and many others.

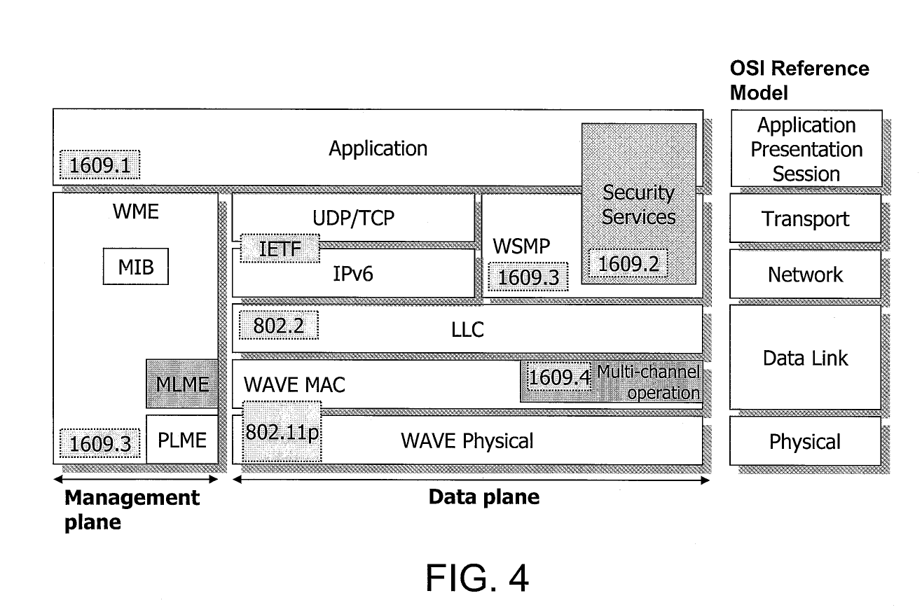

As shown in FIG. 4, it schematically illustrates the architecture in IEEE 1609 Standards for Wireless Access in Vehicular Environments (WAVE). The family of IEEE 1609 standards includes at least the following standards. IEEE 1609.0 Standard provides Wireless Access in Vehicular Environments (WAVE)—Architecture. It describes the WAVE architecture and services necessary for multi-channel DSRC/WAVE devices to communicate in a mobile vehicular environment.

IEEE 1609.1 provides Standard for Wireless Access in Vehicular Environments (WAVE)—Remote Management Services. It specifies the services and interfaces of the WAVE remote management application (as shown “Application” in FIG. 4). It describes the data and management services offered within the WAVE architecture. It further defines command message formats and the appropriate responses to those messages, data storage formats that must be used by applications to communicate between architecture components, and status and request message formats.

IEEE 1609.2 provides Standard for Wireless Access in Vehicular Environments (WAVE)—Security Services. It defines secure message formats and processing. This standard also defines the circumstances for using secure message exchanges and how those messages should be processed based upon the purpose of the exchange.

IEEE 1609.3 provides Standard for Wireless Access in Vehicular Environments (WAVE)—Networking Services. It defines network and transport layer services, including addressing and routing, in support of secure WAVE data exchange. It also defines Wave Short Messages (WSA) using Wave Short Message Protocol (WSMP), providing an efficient WAVE-specific alternative to Internet Protocol version 6 (IPv6) that can be directly supported by applications. Further, this standard defines the Management Information Base (MIB) for the WAVE protocol stack. As shown in FIG. 4, in management plane, WAVE Management Entity (WME) operates with network-layer protocols defined in IEEE 1609.3. The WME includes MIB, MAC Layer Management Entity (MLME) for managing WAVE Medium Access Control (MAC) layer and Physical Layer Management Entity PLME) for managing WAVE Physical (PHY) layer.

IEEE 1609.4 provides Standard for Wireless Access in Vehicular Environments (WAVE)—Multi-Channel Operations. It provides enhancements to the IEEE 802.11p MAC protocols to support WAVE operations.

Additionally, the IEEE 1609 standards rely on IEEE 802.11p for communication in the MAC and the PHY layers. This proposed standard specifies the extensions to IEEE 802.11 that are necessary to provide wireless communications in a vehicular environment.

The IEEE 1609 Standards for WAVE defines the architecture, communications model, management structure, security mechanisms and physical access for high speed (up to 27 Mb/s), short range (up to 1000 meters) and low latency wireless communications in the vehicular environment. The primary architectural components defined by these standards are the On Board Unit (OBU), Road Side Unit (RSU) and WAVE interface.

The IEEE 1609 Standards define how applications that utilize WAVE will function in the WAVE environment as illustrated in IEEE 1609.0, based on the management activities defined in IEEE 1609.1, the security protocols defined in IEEE 1609.2, and the network-layer protocols defined in IEEE 1609.3. Lastly, they provide extensions to the physical channel access defined in IEEE 802.11p to support the WAVE standards in IEEE 1609.4.

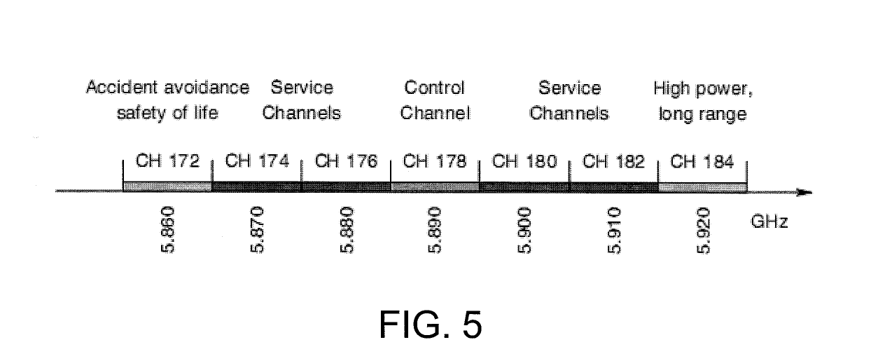

Refer to FIG. 5, the IEEE 1609 Standards use 5.9 Giga Hertz (GHz) band for communication, and rely on IEEE 802.11p for communication in the MAC and PHY layers. For safety consideration and bandwidth limitation, the band (5.9 GHz) is divided into seven channels, including channels CH172, CH174, CH176, CH178, CH180 and CH184. The channel CH178 is defined as control channel (CCH), and the other channels (except for CH178) are defined as service channels (SCHs). According to IEEE 1609 Standards, communication devices include at least one antenna or more, and the time sequence for communication for each duty cycle is divided into a CCH interval and a SCH interval. All devices will be synchronized to alternatively and regularly switch between the CCH interval and the SCH interval for communication, and also alternatively switch the channel frequency of its antenna according to the service which the device connects. The CCH interval is used for transmitting emergency information, security requirement information, wave service advertisement (WSA) packets, or wave short message protocol (WSMP) with higher priority. The SCH interval is used for exchanging messages between regular devices in the users by WSMP, and also used for interchanging information and desired services between the provider and the users. All supporting data formats can use, for example, designated Network Interface Card (NIC) number in MAC layer for unicasting or specific NIC number for broadcasting.

In one embodiment, the system of IEEE 1609 standards includes two device roles, including a channel controller and participants, both of which utilize processors and channel-switching radios. Communications take place among the participants, and between the channel controller and participants. For illustrating embodiments of communications using WSMP of the disclosure, the channel controller is referenced as “service provider” and each of the participants is references as “user device.” The service provider will repeatedly broadcast WSAs in the control channel, which all user devices covered by its broadcasting area will access regularly after a predetermined time.

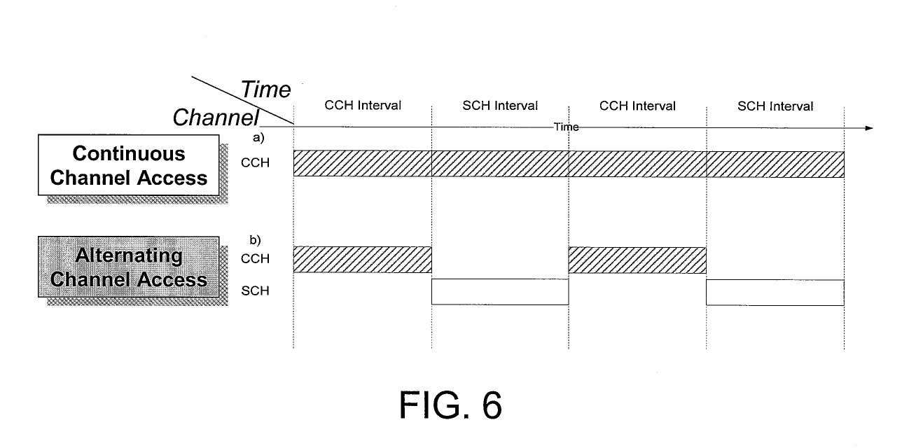

As shown in FIG. 6, in an alternating channel access mode, the provider repeatedly sends the WSAs during the CCH intervals. The WSA will advise the user devices about provider service identifiers (PSIDs) for different services, the corresponding channel numbers, and etc. If the user needs one of the services provided by the provider, the user device may monitor the broadcasting information in the CCH during the CCH interval. The user device compares the content of the WSA such as the PSIDs, channel information, and etc., with the desired service from the user.

If it matches, the user application in the user device will be informed and begin to communicate through the channel providing the desired service, which as shown in an alternating channel access mode. The user device will still monitor the CCH during the CCH interval, and receive the desired service from the selected channel during the SCH interval. If none of the services matches the desired service, the WSA will be disregarded.

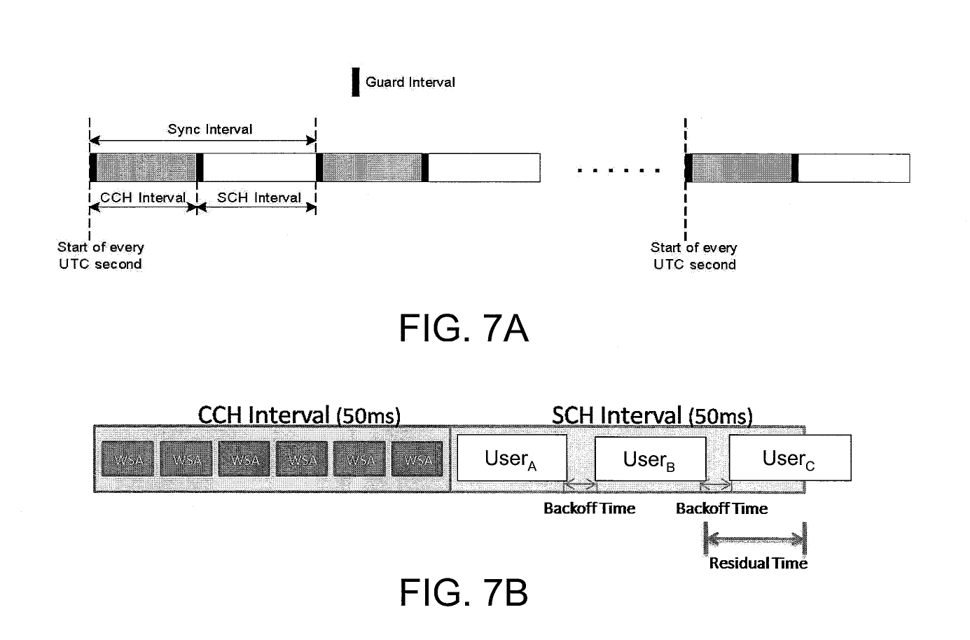

Synchronizing in time for communications among the user devices or between the service provider and the user devices is one of main issues in IEEE 1609 standards. For avoiding communicating failure due to synchronization error in time, a guard interval is added between the CCH interval and the SCH interval for each sync interval (duty cycle), as shown in FIG. 7A. The service can only be received during the SCH interval, and the guard interval is inserted between the CCH interval and the SCH interval for safety communication, the throughput for the service can only be less than half of the transmission rate of the hardware devices.

In addition, in the IEEE 1609 standards, both of the CCH interval and the SCH interval are configured to be 50 milliseconds (ms). If the communication is affected by the environmental factors or the distributed coordination function (DCF) contention in the limited 50 ms, it is difficult to satisfy the quality of service (QoS) requirement. As shown in FIG. 7B, during the CCH interval, a plurality of WSAs is repeatedly broadcasted out from the provider. During the SCH interval, the messages User_{A}, User_{B}, User_{C} are sequentially sent out with a backoff time is interposed therebetween for to the distributed users. Because the time interval is limited to 50 ms, the message User_{C} will be delayed to next SCH interval, and the residual time will be wasted, which actually affects the throughput of the system.

IEEE 1609 standards consider some specific requirements of real-time service for the transportation, for example, Electronic Toll Collection (ETC) service. Except for the alternative access to the CCH and SCH, an extended access mode is supported for such applications. The extended access mode allows the user device does not have to switch back to the CCH for a preset time. However, in the regular extended access mode, the provider should include more than one antenna, at least including one for the CCH and the other for SCH. The user application in the user device has to provide an extended period (or means that a certain number of sync intervals extended) for accessing the SCH. When the extended interval is expired and the user device has to switch back to the CCH, the expected real-time service is satisfied.

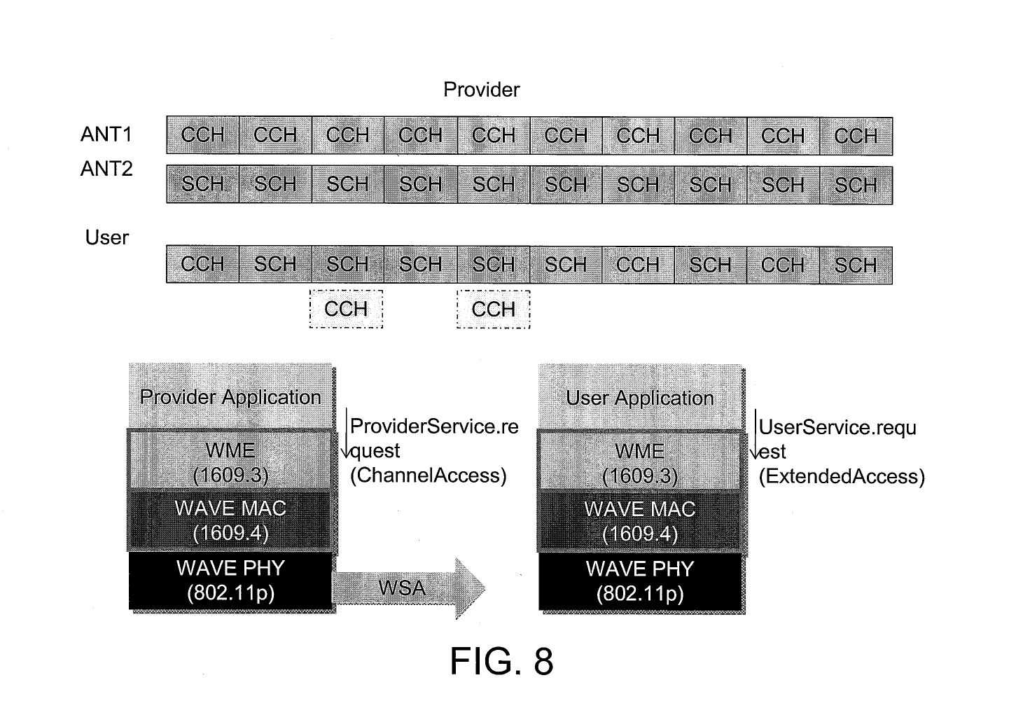

Please refer to FIG. 8, the provider includes at least two antennas ANTI and ANT2. The antenna ANT1 is specifically used as the CCH for repeatedly broadcasting the control information. The antenna ANT2 is specifically used as the SCH for providing the service. A message ProviderService.request of the control information from the provider indicates that the extended access to the SCH is available or not. The user application can allow the user to select an extended period for extending SCH access.

For example, according to the paragraph [IEEE 1609.3] 8.2.4.7.3 Channel Access, it defines that “if present, this indicates the times, in terms of channel interval, during which the provider is on the associated SCH. Its length is one octet.” That is, the field “Channel Access” in the WSA received from the provider may be used to indicate the extended access to the SCH is available or not. If the value of the “Channel Access” field is “0”, it indicates that the provider provides extended SCH access and the provider has multiple antennas. If the value in the “Channel Access” field is “1”, it indicates that the provider provides service content access during the SCH interval only.

According to the IEEE 1609 standards, the user application can register the desired services and set the “ExtendedAccess” field by using a message UserService.request to the protocol layer of the user device. A value of “ExtendedAccess” field in the UserService.request message is used to indicate the number of sync intervals to be extended. If the value of “ExtendedAccess” field is equal to 0, that means the user device does not desire to use extend access to the SCH. If the value of “ExtendedAccess” is large than 0, that means there are the value of sync intervals to be extended for access. The value of “ExtendedAccess” field can be configured to be 0˜65535. As shown in FIG. 8, in the embodiment, the value of “ExtendedAccess” field is 2, which indicates that the user device extends 2 sync intervals to access the service. As shown, the user device does not switch back to the CCH and continuously access the service for more two sync intervals.

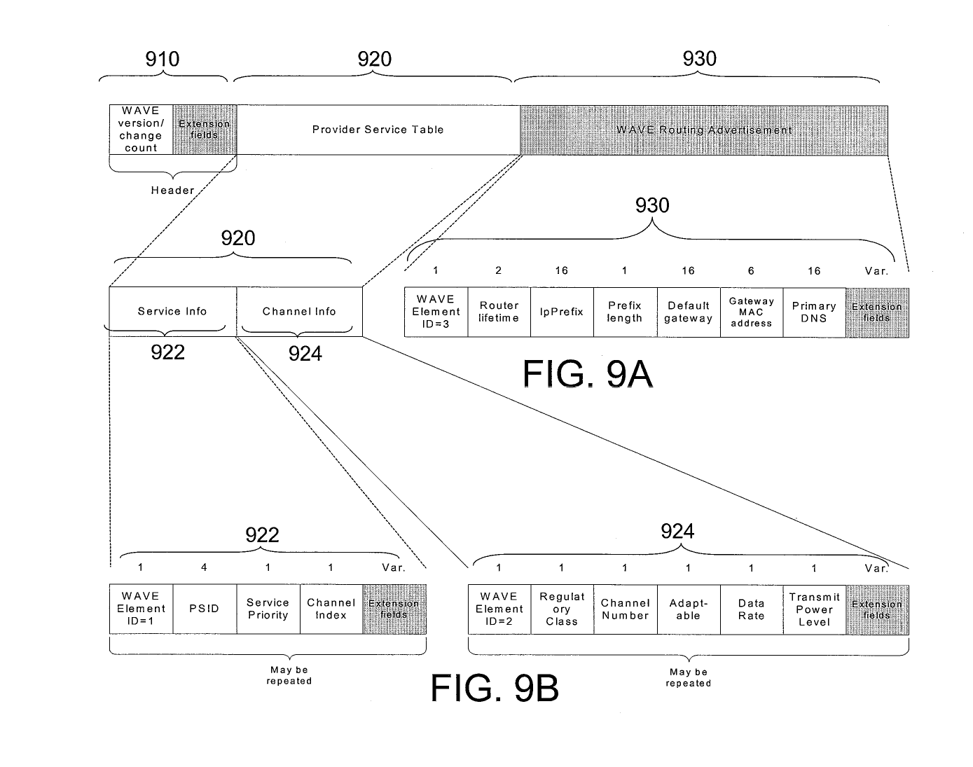

FIG. 9A illustrates content of a WSA packet in the IEEE 1609 standards, and FIG. 9B illustrates further detailed content of the WSA. The WSA packet includes at least a header 910, a provider service table 920, and a WAVE routing advertisement 930. The header 910 includes a “WAVE version/change count” field, and an “Extension” field. The provider service table 920 includes a “Service Info” field 922 and a “Channel Info” field 924. The WAVE routing advertisement 930 includes a plurality of fields for routing information. The “Service Info” field 922 includes “WAVE Element ID=1”, “provider service identifiers (PSIDs)”, “Service Priority”, “Channel Index” and some extension fields. The WSA packet can includes one or a plurality of the “Service Info” fields 922, which can be repeated. The “Channel Info” field 924 includes some fields about the channel information, including some extension fields. The WSA packet can includes one or a plurality of the “Channel Info” fields 924, which can be repeated.

In one embodiment of the disclosure, a “Channel Access” field in the Channel Info 924 of the WSA received from the provider may indicate the extended access to the SCH is available or not. If the value of the “Channel Access” field is “0”, it indicates that the provider provides extended SCH access. If the value in the Channel Access field is “1”, it indicates that the provider provides service content access during the SCH intervals only.

In such standards, however, the provider can only inform the user that extended access is available or not. If the user application requests for extended access, it should be done when the user application initially registers the desired services and sets the “ExtendedAccess” field in the UserService.request to the protocol layer of the user device. It is not permitted to request for extended access on demand. Instead, the user device only allows the user application setting the extended period in the beginning of providing the service in the extended SCH access mode, and then, till the period is expired, the user device has to switch back to the alternating access mode. Furthermore, in the standards, it is also not specified for the user device to terminate or stop the extended access before the period is expired.

In consider the characteristics of IEEE 1609 standards, especial for the extended SCH access, one embodiment of the disclosure discloses that the provider can dynamically extend the SCH access by one or more user devices to temporarily increase throughput, or in case that DCF contention occurs. The disclosure does not require the provider to have at least two antennas to provide the extended access, and the service device can enter or terminate the extended SCH access mode on demand.

In the embodiment, the user application is forced to register the desired services and sets the “ExtendedAccess” field to the protocol layer of the user device. A sufficient time period for the extended SCH access is set in the beginning. That is, the value of “ExtendedAccess” field is configured to be a large number that is sufficient to access the SCH by the disclosed method. In one exemplary embodiment, the value of “ExtendedAccess” is configured to be the largest number “65535”, or to be sufficient for the proposed system. The service provider broadcasts WSAs during the CCH intervals, and each of the WSA includes the channel access information, for example, to indicate that extended SCH access is available or only alternating access is allowed.

In the provider phase, the provider can change the content of the field according requirements such as the quality of communication. That is, the provider can change the value of “Channel Access” field to “0” or “1” under the discretion of the provider according to the communication quality or specific requirement (for example, QoS for specific user devices). In one exemplary embodiment of the disclosure, as shown in FIG. 9, a “Channel Access” field in the extension fields of the “Channel Info” field 924 is used in the disclosure. When the “Channel Access” field is “0”, it indicates that extended SCH access is permitted, that means that the provider can continuously provide the service. If the “Channel Access” field is “1”, it indicates that the service is provided by alternating access, which means the provider only provide service during the SCH intervals.

In the user device phase, when the user application registers the desired services to the protocol layer of the user device, the value of the “ExtendedAccess” field in the UserService.request can not be “0”, for example, the value of the “ExtendedAccess” field can be a value which is sufficient enough to proceed with the extended SCH access. In one embodiment, the value is set as “65535”, which means unlimited access. If the WSA received from the provider notices that value in the field of the “ChannelAccess” is “1” (alternating access), owing to the restriction of the provider, the user device can only access the service with the alternating access mode. In the similar manner, if the WSA notices that value in the field of the “ChannelAccess” is “0” (continuous access), the user device can know that the access mode is changed and then access the service by the extended SCH access mode, instead of accessing with the alternating access mode. By such manner, the provider can change the access mode under discretion or on demand according to the communication quality or specific requirement (for example, QoS for specific user devices).

When the service is accessed with the alternating access mode, the WSAs are broadcasted in the CCH intervals only. However, when the service is accessed with the extended SCH access mode, the WSAs are broadcasted in the SCH intervals. In addition, when the period of the extended SCH access mode is going to expire, the WSAs should only be broadcasted on one CCH interval and one SCH interval beforehand to all user devices.

Hereafter some cases are illustrated for explaining difference possible implementation of the disclosure.

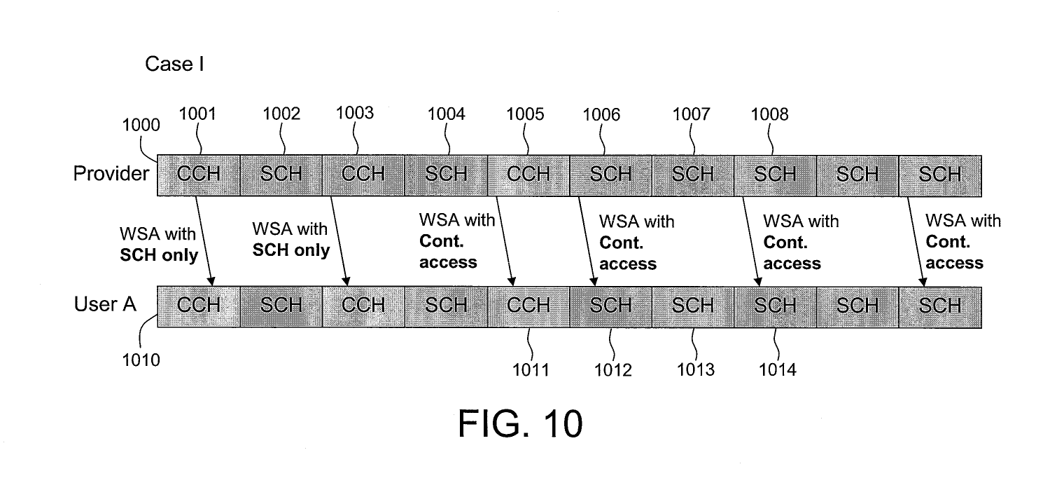

Refer to FIG. 10, which illustrates a system that provides an extended SCH access on demand between a provider and a user device A. When the user device A wants to join the services provided by the provider, user application has to register the desired services to the protocol layer of the user device with a request that a value of the “ExtendedAccess” field is set to a value which reflects a time period sufficient enough to proceed with the extended SCH access. In one embodiment, the value is set as “65535”, which means unlimited access.

The provider will generate a WSA with access information. If the access information in the WSA reflects that the provider can only provide service with an alternating access mode, which means the provider only provide service during the SCH intervals. The user device A begins to access the service in the alternating access mode, even the user device A has requested for an extended SCH access. As shown, the time sequence 1000 in the provider is synchronized with the time sequence 1010 in the user device A. In the alternating access mode, control information is sent out by the provider during the intervals CCH 1001, CCH 1003, and the user device A also receives the information during the corresponding CCH intervals.

In the case that the provider finds channel quality is too low or some other specific requirement (for example, QoS for specific user devices), the provider in the interval CCH 1005 broadcasts a WSA with the access information that the extended SCH access is available in the service provided by the provider. The user device A will obtain the WSA in the interval CCH 1011, and then quickly switch to receive the service with the extended SCH access mode. As shown, in the intervals SCH 1006˜1008 and the following intervals, the user device A will access the service in the synchronized intervals 1012 without switching back to the CCH. When the service is accessed with the extended SCH access mode, the WSAs are broadcasted in some SCH intervals. The arrangement is desired to consider the other associated user devices, which are not successfully switch from the alternating access mode to the extended SCH access mode.

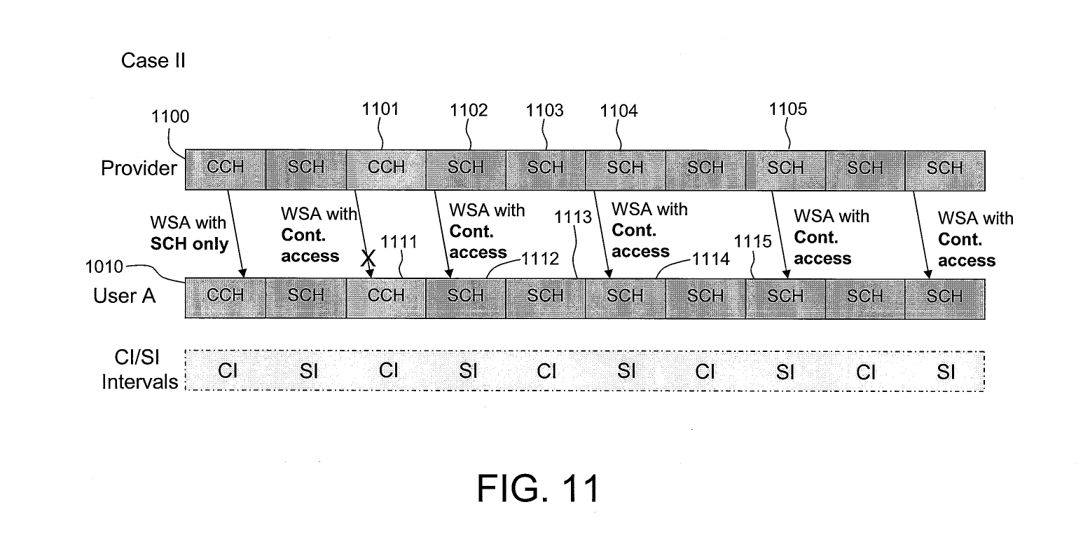

Refer to FIG. 11, which illustrates a system that provides an extended SCH access on demand between a provider and a user device A. As illustrated above, the user devices A registers the desired services to the protocol layer of the user device for a time period sufficient enough to proceed with the extended SCH access. For example, a value of an “ExtendedAccess” field in UserService.request is set to “65535”, which means unlimited access. The communication between the provider and the user device A is similar as described in FIG. 10. The time sequence 1100 in the provider is synchronized with the time sequence 1110 in the user device A. When the provider finds channel quality is too low or some other specific requirement (for example, QoS for specific user devices), the provider in the interval CCH 1101 broadcasts WSA with extended SCH access available information. The user device A then begins to receive the services with the extended SCH access mode.

However, in some cases, the user device A fails to receive the WSA with extended SCH access available information in the interval CCH 1111 from the provider. The user device A still remains in the alternating access mode to access the control information and the service during the CCH/SCH intervals alternatively, as shown in the intervals CCH 1111, SCH 1112. The provider will broadcast WSAs during the SCH intervals, for example, during the interval SCH 1102, because during the SCH intervals, all associated user devices will receive the information from the provider and the WSAs can be added to the information sent out during the SCH interval. The user application in the user device A obtains the WSA in the interval CCH 1112, and then quickly switches to access the services with the extended SCH access mode. As shown, the user device A will access the service in the synchronized intervals 1112˜1114 and following intervals without switching back to the control channel. The arrangement is desired to consider the other associated user devices, which are not successfully switch from the alternating access mode to the extended SCH access mode.

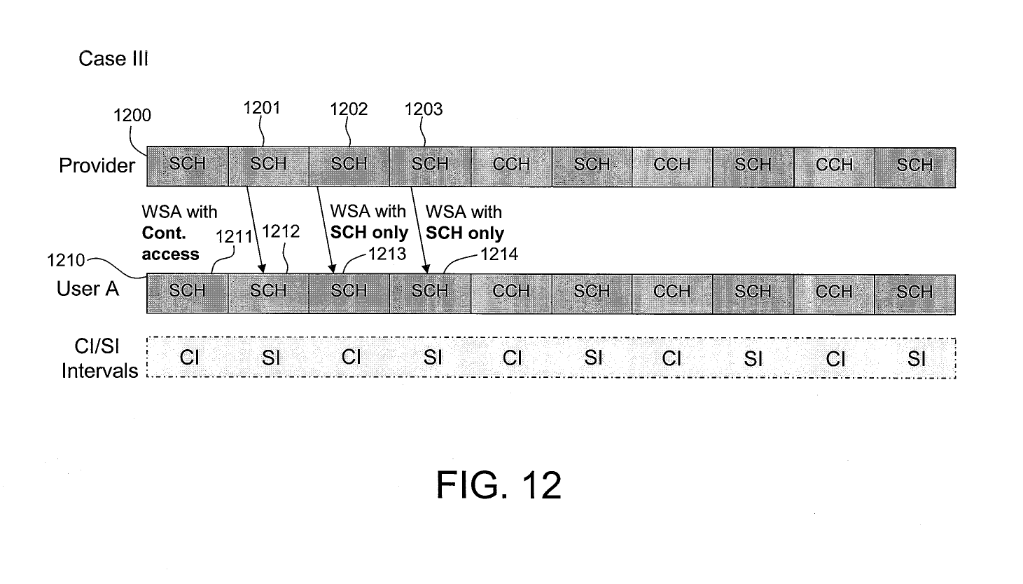

Refer to FIG. 12, which illustrates how the communications between a provider and a user device A switch from the extended SCH access mode to the alternating access mode. The time sequence 1200 in the provider is synchronized with the time sequence 1210 in the user device A. The user device A communicates with the provider with the extended SCH access mode, as shown in the intervals SCH 1211, 1212. When the provider finds channel quality is much better, the provider can make the decision to switch back to the alternating access mode. The WSAs with the information which indicates alternating access only information are broadcasted one CCH interval and one SCH interval beforehand to all user devices. As shown in FIG. 12, for example, the WSA with extended SCH access is still broadcasted in the interval SCH 1201. When the provider decides to switch back to the alternating access mode, the WSA with alternating access only information is sent out during the intervals SCH 1202 and 1203, the user devices A will be noticed with the information during the intervals SCH 1213, 1214. The user application of the user device A will obtain the WSA and then switch back to access with the alternating access mode during the interval SCH 1214.

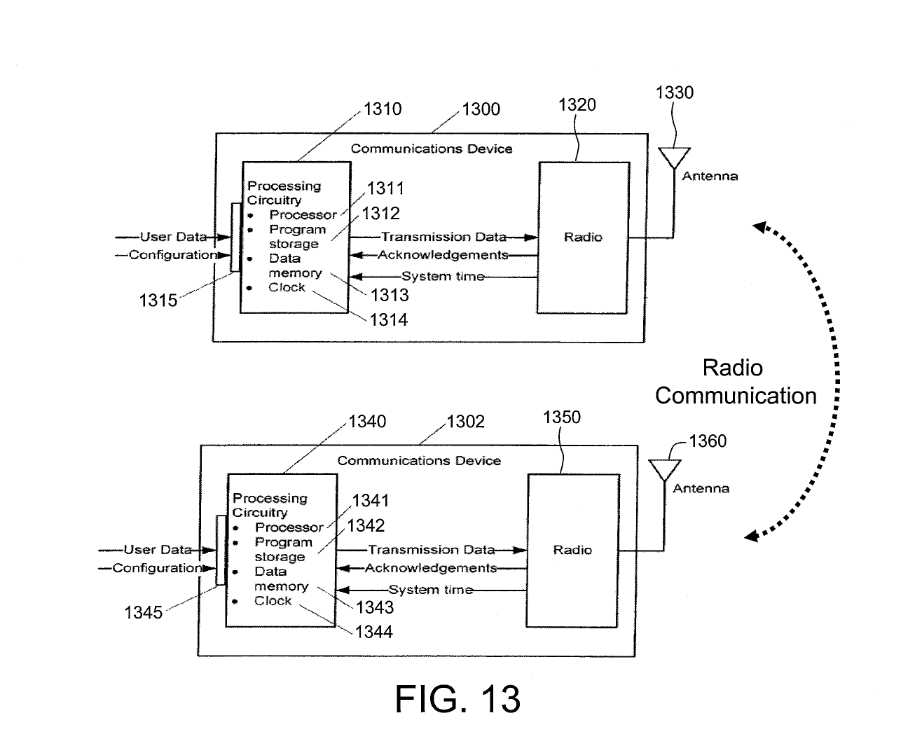

FIG. 13 illustrates an exemplary block diagram for a system including a provider 1300 and a user device 1302 in an embodiment of the disclosure. As shown, both of the provider 1300 and the user device 1302 include components, which may be identical, though their functions are distinct.

As shown, both of the provider 1300 and the user device 1302 include a processing circuitry (1310 and 1340), channel switching radio (1320 and 1350), antenna (1330 and 1360). The provider 1300 may include one or more antennas for alternatively providing control information and service content, or one antenna for providing the control information and the other for providing the service content, which depends on designs required. The processing circuitry (1310 and 1340) sends the transmission data to the channel switching radio (1320 and 1350), and the channel switching radio (1320 and 1350) transmits the acknowledge information and system time for synchronization to the processing circuitry (1310 and 1340).

The processing circuitry 1310 and 1340 handles general communications tasks, as well as the processes associated with the disclosure. The processing circuitry 1310 includes a processor 1311, a program storage unit 1312, a memory unit 1313 for storing data, a clock generating unit 1314 and a communication port 1315 for receiving and transmitting user data or configuration information. In a similar arrangement, the processing circuitry 1340 includes a processor 1341, a program storage unit 1342, a memory unit 1343 for storing data, a clock generating unit 1344 and a communication port 1345 for receiving and transmitting user data or configuration information.

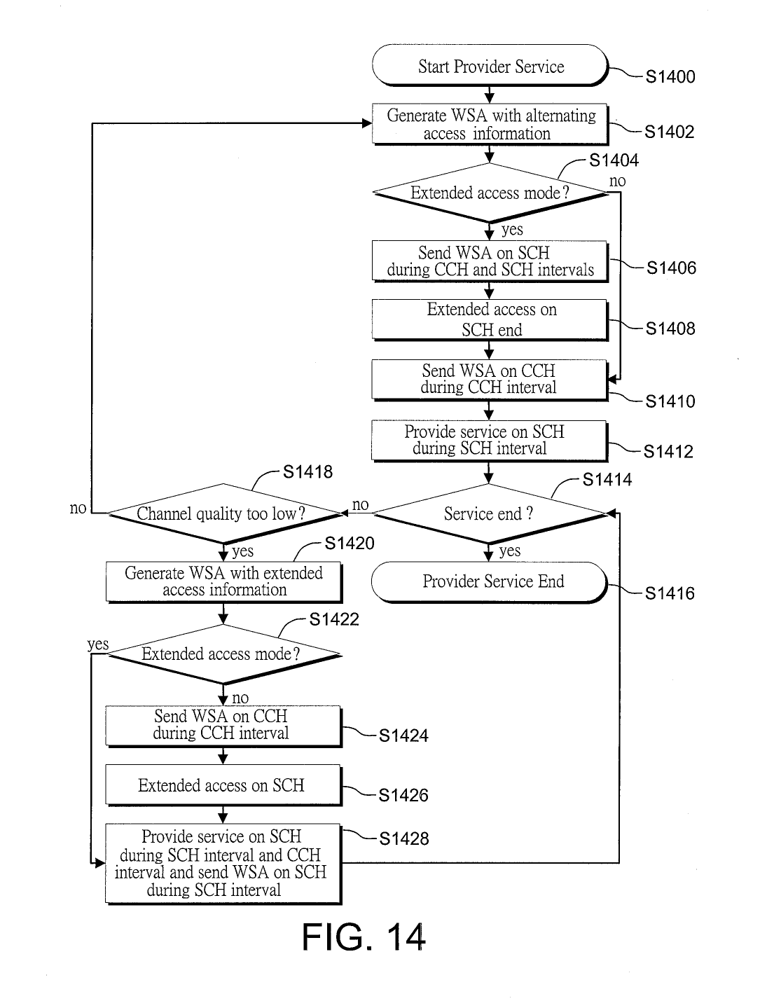

One exemplary embodiment of processes associated with the mechanism for extended SCH access on demand between the provider 1300 and the user device 1302 to improve throughput in an alternating channel access of multiple channels is depicted in FIG. 14.

Refer to FIG. 14, a provider starts to provide a plurality of services, as in step S1400. The provider will generate a plurality of WSA with alternating access information, as in step S1402. If any user device wants to join one of the services provided by the provider, a user application of the user device has to register the desired services to a protocol layer of the user device. In the embodiment, the user application sends a message UserService.request to the protocol layer of the user device for accessing services. In the UserService.request, a value of the “ExtendedAccess” field is set as a value which reflects a time period sufficient enough to proceed with the extended SCH access. In one embodiment, the value is set as “65535”, which means unlimited access. Because the WSA with alternating access information received from the provider indicates that only alternating access is available, the user device can only receive the control information and the service content alternatively from the CCH and SCH during the respective CCH intervals and the SCH intervals.

As in step S1404, the provider will identify whether the service is provided with the regular alternating access mode or with an extended SCH access mode. If the service is providing with the regular alternating access mode, the process will go to step S1410, in which WSA is sent on CCH during the CCH intervals, and then, as in step S1412, the service is provided on SCH during the SCH intervals, until the service is ended, as in step S1414. The service from the provider is ended in step S1416. If the service is provided with the extended SCH access mode, the steps S1406 and S1408 are performed before the step S1410, which means that the provider decides to change the access mode from extended SCH access to alternating access for providing the service. In step S1406, the provider sends the WSA with the alternating access information, generated in step S1402, on the SCH during the CCH intervals and the SCH intervals to terminate the extended SCH access mode. In step S1408, when the extended access on SCH ends, the process will go to step S1410, as aforesaid.

As in step S1414, if the service has not ended, the process will go to step S1418, in which the provider will monitor the channel quality. If the channel quality is satisfied, the process will go back to step S1402. If the provider finds the channel quality is too low, for example, and may not satisfy the QoS, the provider will generate WSA with extended SCH access available information, as in step S1420. In step S1422, the provider will identify whether the service is provided with the alternating access mode or with the extended SCH access mode. If the service is provided with the regular alternating access mode, the process will go to step S1424 and S1426, which means that the provider decides to change the access mode from alternating access to extended SCH access for providing the service. In step S1424, the WSA with the extended SCH assess information, generated in step S1420, is sent on CCH during the CCH intervals, and then, as in step S1426, the service is provided with the extended SCH access mode. If the service will be remained providing in the extended SCH access mode, the process will go to step S1428, in which the provider provides the service on SCH during the SCH intervals and the CCH intervals, and the WSA is sent on the SCH during the SCH intervals, and then the process will go back to step S1414 to determine the service is end.

Although the present exemplary embodiment has been described with reference to the above exemplary embodiments, it will be apparent to one of the ordinary skill in the art that modifications to the described exemplary embodiment may be made without departing from the spirit of the invention. Accordingly, the scope of the invention will be defined by the attached claims not by the above detailed descriptions.

What is claimed is:

1. A method for dynamically adjusting channel utilization rate, adaptive to channel access between a provider and one or a plurality of user devices in a wireless environment, wherein the provider provides control information on a control channel (CCH) or a service channel (SCH) and service content on the SCH, the method comprising:
determining an access mode of accessing the service content between the provider and the user device by the provider depending on a requirement of a service between the provider and the user device, the access mode comprising an alternating channel access mode and an extended SCH access mode; and
the provider advising the user device the access mode between the provider and the user device or the plurality of the user devices, and
when the access mode being switched from the alternating channel access mode to the extended SCH access mode, the provider first providing the control information on the CCH during CCH intervals then on the SCH during following SCH intervals, and the user device accessing the control information and accessing the service content on the SCH during the CCH intervals and the SCH intervals until the control information indicates switching the access mode.

2. The method as claimed in claim 1, wherein a plurality of the control channel (CCH) intervals and service channel (SCH) intervals are arranged by turns for the user device to access the control information on the CCH and the service content on the SCH by turn in the alternating channel access mode.

3. The method as claimed in claim 1, wherein before determining an access mode between the provider and the user device by the provider, an user application of the user device sending a request to register the extended SCH access mode to a protocol layer of the user device to claim the capability to change the access mode by the provider.

4. The method as claimed in claim 1, wherein in the step of the provider advising the user device the access mode between the provider and the user device by providing a service advertisement message with a control information for accessing in the alternating channel access mode or the extended SCH access mode.

5. The method as claimed in claim 4, wherein the control information in the service advertisement message for accessing in the alternating channel access mode or the extended SCH access mode is indicated by the value in a field of “Channel Access” in IEEE 1609.3 standard.

6. The method as claimed in claim 4, wherein the control information in the service advertisement message for accessing in the alternating channel access mode or the extended SCH access mode is indicated by a specific field in IEEE 1609.3 standard.

7. The method as claimed in claim 1, wherein if one of the plurality of the user devices fails to changing the access mode from the alternating channel access mode to the extended SCH access mode during the CCH interval, the user device obtains the control information and the service content on the SCH during the SCH intervals, and changes the access mode by the control information.

8. The method as claimed in claim 1, wherein the provider determines the access mode between the provider and the user device according to channel quality between the provider and the user device.

9. A system for dynamically adjusting channel utilization rate, adaptive to channel access of multiple channels in a wireless environment, the system comprising:
a provider, providing control information and service content; and
a plurality of user devices, communicating with the provider, for receiving the control information and the service content,
wherein the provider determining the access mode of accessing the service content between the provider and the plurality of user devices by considering requirements of the service between the provider and the user devices; and advising the user devices the access mode between the provider and the plurality of user devices, wherein
when the access mode being switched from an alternating channel access mode to an extended SCH access mode, the provider first providing the control information on the control channel (CCH) during CCH intervals then on the SCH during following SCH intervals, and the user device accessing the control information and accessing the service content on the SCH during the CCH intervals and the SCH intervals until the control information indicates switching the access mode

10. The system of claim 9, wherein the provider comprising:
a processing circuitry, providing transmission data including the control information and the service content, and a channel information;
a channel switching radio, for receiving the transmission data from the processing circuitry, and broadcasting the control information and the service content according to the channel information, wherein the channel switching radio provides acknowledges from the plurality of user devices and a system time to the processing circuitry; and
at least one antenna, sending out the control information and the service content respectively on the CCH and the SCH.

11. The system as claimed in claim 9, wherein before determining an access mode between the provider and the user device by the provider, an user application of the user device sending a request to register the extended SCH access mode to a protocol layer of the user device to claim the capability to change the access mode by the provider.
